(19) United States
(12) Patent Application Publication
(10) Pub. No.: US 2003/0125057 A1
(43) Pub. Date: Jul. 3, 2003

(54) System and method for automatic synchronization of managed data

(76) Inventor: Troy Raymond Pesola, Champlin, MN (US)

Correspondence Address: Wayne P. Bailey, Storage Technology Corporation, One StorageTek Drive, MS-4309, Louisville, CO, 80028-4309, US

(21) Appl. No.: 10/034,704

(22) Filed: Dec. 27, 2001

(51) Int. Cl. H04B 15/00

(52) U.S. Cl. 455/502; 370/350; 375/355; 375/358

(57) ABSTRACT

A system and method for synchronizing managed data stored by at least two computing devices include establishing a communication link between first and second computing devices, automatically identifying the managed data stored on the first computing device for synchronization, automatically transferring synchronization information associated with the managed data stored on the first computing device to the second computing device over the communication link, reconciling differences in the managed data stored on the first and second computing devices based on the synchronization information to generate reconciliation information, and transferring the reconciliation information from the second computing device to the first computing device to synchronize the managed data. In one embodiment, a plurality of mobile computing devices which communicate with a stationary device via a wireless network with the communication link and data synchronization automatically established based on proximity of the devices.

### BACKGROUND OF THE INVENTION

1. Field of the Invention

The present invention relates to a system and method for synchronizing information to facilitate collaboration among users of mobile and stationary computing devices.

2. Background Art

Various types of computing devices are relied upon to enhance both personal and business productivity. Personal digital assistants (PDAs), laptop computers, hand-held computers, and similar devices are being used to store, access, and manipulate larger quantities and increasingly more important data. Most mobile devices include some method or mechanism for exchanging data with other computing devices to provide data input, back-up, or sharing of data to allow multiple users to work with the same data. While methods for data exchange continue to be improved and refined, many remain cumbersome and time consuming, which results in users being reluctant to regularly perform such exchanges.

Users of mobile computing devices often need to synchronize data among multiple devices, which may include other mobile devices or stationary machines. The process of synchronization harmonizes data between or among computing devices such that the same information resides in multiple locations after the process has been completed. This provides a mechanism for propagating additions, deletions, and modifications of data among the various locations. Some prior art strategies focus on database manipulation to provide synchronization. One approach for providing enterprise connectivity to handheld devices uses a database scripting language (such as SQL) to extract information from an enterprise database for use on the portable system. Another approach synchronizes data between a server and client database by comparing the contents of the database for the server and the client and ensuring that the latest information is contained in each.

Collaboration allows multiple users to work on the same set of information and requires some of the same elements as synchronization. Similar to synchronization, collaboration requires a method for combining data manipulated by different users, usually with some form of version or revision control. One approach for providing collaborative document control uses encryption to ensure restricted access, confidentiality and non-reputability of changes made to a shared set of documents. This approach controls access to the information allowing only authorized individuals to make changes. This allows changes to documents or sections of documents to be approved by members of the collaboration group. Another prior art approach for collaboration focuses on how a shared object is saved. A strategy is provided for combining changes and resolving conflicts for incorporation into a final view of a document.

While various approaches have been developed for collaboration and synchronization of information, none leverage recent advances in communication technology to provide an efficient system for transparently managing data residing on portable storage and/or computing devices.

### SUMMARY OF THE INVENTION

The present invention provides a system and method for synchronizing managed data. The system and method include establishing a communication link between first and second computing devices, automatically identifying the managed data stored on the first computing device for synchronization, automatically transferring synchronization information associated with the managed data stored on the first computing device to the second computing device over the communication link, reconciling differences in the managed data stored on the first and second computing devices based on the synchronization information to generate reconciliation information, and transferring the reconciliation information from the second computing device to the first computing device to synchronize the managed data. In one embodiment, the first computing device is a mobile device which communicates with a stationary device via a wireless network with the communication link automatically established based on proximity of the devices.

The present invention provides a number of advantages. For example, the present invention leverages concepts of synchronization and collaboration by providing transparent synchronization of data among mobile computing devices or between mobile and stationary computing devices. Automatic detection of a mobile device containing managed data initiates the synchronization process without the need for user intervention. The present invention is particularly suited for a wireless implementation to provide users of mobile computing devices a simple tool for sharing and synchronizing of data through a common server. The invention provides for a set of highly mobile computing devices that can be used by a team to collaborate on one or more sets of managed data.

The above advantages and other advantages, features, and objects of the present invention are readily apparent from the following detailed description of the best mode for carrying out the invention when taken in connection with the accompanying drawings.

### BRIEF DESCRIPTION OF THE DRAWINGS

FIG. 1 is a block diagram illustrating a representative system for managed data synchronization according to one embodiment of the present invention; and

FIG. 2 is a diagram illustrating control logic for a representative system or method for synchronization of managed data according to one embodiment of the present invention.

### DETAILED DESCRIPTION OF THE PREFERRED EMBODIMENTS

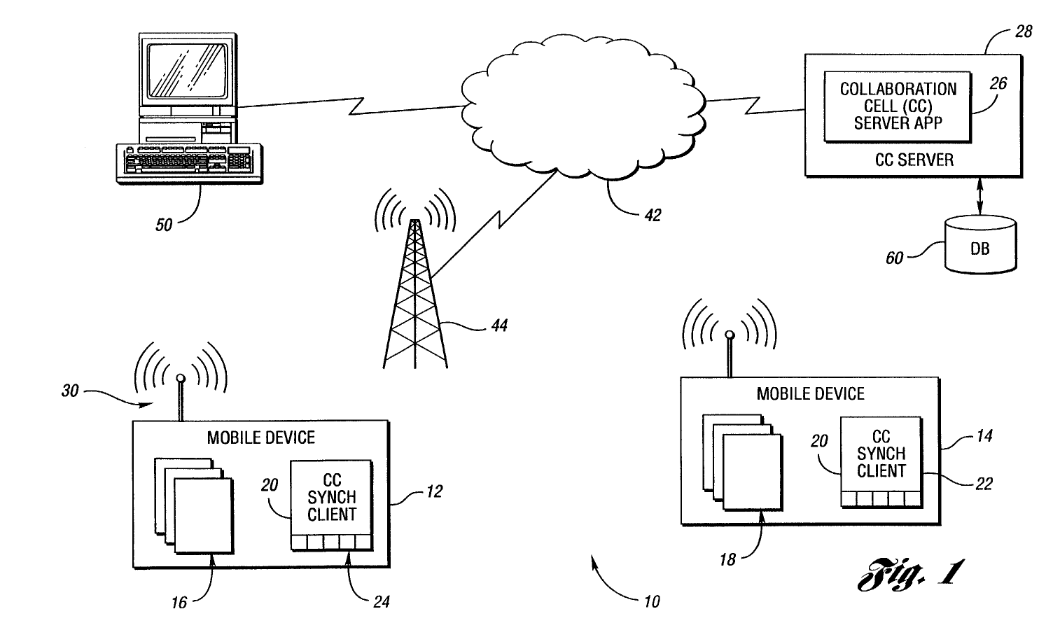

Referring to FIG. 1, a block diagram illustrating a representative system for synchronization of managed data according to one embodiment of the present invention is shown. System 10 includes various computing devices that form a collaboration cell or workgroup. System 10 preferably includes at least one portable computing device, such as portable computing devices 12, 14. Portable computing devices 12, 14 may include any of a number of general purpose and dedicated microprocessor based devices such as personal digital assistants (PDAs), laptop computers, hand-held computers, and the like. Portable computing devices 12, 14 preferably include a computer readable storage medium for storing managed data 16, 18 in addition to a client synchronization application 20, 22. Managed data 16, 18 represent groups of documents that have been identified as part of the collaboration cell. These documents may be stored in independent or related files that are to be shared with a group of people working on a particular task or project, for example. Portable computing devices 12, 14 may be used to make modifications to the managed data. Modifications may include adding new information, modifying existing information, and/or deleting information depending upon the particular application and implementation. Client synchronization application 20 generates synchronization information 24 based on modifications to managed data 16. Synchronization information 24 is used to automatically synchronize managed data 16 with a collaboration cell synchronization server application 26 running on a collaboration server 28 as explained in greater detail below.

Portable computing devices 12, 14 include a communication interface 30, which is preferably a wireless interface. However, depending upon the particular application, one or more mobile devices may have a wired interface in place of, or in addition to a wireless interface. Of course, wired networking does not provide the same level of portability as wireless networking and is therefore less desirable, but within the scope of the present invention. The mobility of portable computing devices using wireless networking facilitates automatic synchronization as described below. Otherwise, the user is required to manually connect to the collaboration cell.

Computing devices 12, 14 establish a communication link with one or more synchronization servers 26 via a communication network 42, which may include one or more wireless access points or gateways 44. In one embodiment, a communication link is automatically established between a portable computing device 12, 14 and server 28 when the portable device is within a predetermined proximity of the server. This may be accomplished by appropriate configuration of network addresses of the communication interfaces 30 of the portable devices and collaboration server 28. For example, one known wireless communication protocol periodically broadcasts a beacon signal that is recognized by similarly configured devices to establish the initial communication link. The initial communication link may automatically launch the collaboration client on the mobile device which may then send identifying or authentication information which is used to determine whether automatic synchronization of managed data (and which managed data) should be initiated as described below. System 10 may also include one or more computers 50 that communicate with server 28 via a persistent wired or wireless connection to network 42. Computing devices connected via a persistent connection may trigger synchronization manually or periodically based on changes made to the managed data, or some other external event, such as a mobile device being synchronized with the collaboration cell server, for example.

As also illustrated in FIG. 1, collaboration server application 28 may include a database to provide version control or a revision history, for example. In one embodiment, database 60 includes a plurality of managed data sets with each managed data set associated with one or more mobile computing devices and/or users. In addition to tracking changes or revisions to managed data, collaboration server application 28 communicates with corresponding collaboration clients 20, 22 to exchange synchronization information and manage changes made to the documents, files, or information identified as part of the collaboration managed data set associated with a particular computing device and/or user.

As described above, managed data 16, 18 modified by a portable computing device 12, 14 generates corresponding synchronization information which is subsequently used by synchronization server application 26 to provide synchronization of the managed data. Managed information modified by mobile computing device 12, 14 will be reconciled with corresponding managed information stored on server 28. In addition, information modified by other portable or mobile computing devices that has been transferred to server 28 will be updated on mobile computing device 12, 14. When the synchronization process has been completed, server 28 and mobile computing devices 12, 14 associated with the collaboration cell 10 will contain a consistent image of the latest version of the managed information or data.

Collaboration, synchronization server application 26 preferably includes means for reconciling changes based on the synchronization information. Concurrent, inconsistent, or conflicting modifications to managed data will need to be reconciled before being incorporated into the managed data. For example, mobile computing device 12 may modify a document contained within a particular managed data set stored on a computer readable storage medium associated with device 12 by adding information while outside of the collaboration cell. Likewise, mobile computing device 14 may delete the same document or a portion thereof contained within the managed information set stored on its associated computer readable storage medium while outside the collaboration cell. When device 14 is moved within the range of the collaboration cell, the information is automatically synchronized via the client/server synchronization applications as described above resulting in deletion of the document. However, the document and/or an appropriate reference is saved within the version control or revision history database 60. When device 12 is moved within the range of the cell, an automatic synchronization is attempted. However, when the synchronization information attempts to modify the document that was previously deleted by device 12, a conflict occurs with corresponding conflict information generated that identifies the nature and source of the conflict. Conflict information may require manual intervention to resolve the conflict and reconcile the images of the managed data. Revision history or version control 60 preferably tracks reconciliation information and its associated source, whether generated manually by a user or automatically by the collaboration cell synchronization server application 26 or other reconciliation application running on server 28.

In operation, when a mobile or portable computing device 12, 14 enters a collaboration cell 10, a communication link is established between the mobile device 12, 14 and the collaboration server 28 to form an ad-hoc or pico-network. These ad-hoc or pico-networks are automatically formed and disbanded as compatible and properly configured mobile devices come within proximity of one another and/or a corresponding server. While illustrated as a client/server application, the present invention may also be implemented within a flexible peer to peer architecture based on current dynamic networking technology. In one preferred embodiment, a radio frequency wireless communication link is automatically established based on proximity of the portable device 12, 14 and the collaboration server 28 and/or wireless access point 44. Once an initial communication link is established, identification or authentication information may be exchanged to uniquely identify computing device 12, 14 and/or associated users. For example, a hardware address of a network interface card, such as a MAC address may be used to automatically identify device 12, 14 and associated managed data sets residing on collaboration server 28. Depending upon the particular application, user identification/authentication may be used in place of, or in combination with, device identification. User identification and authentication may be provided by a password, hardware key, digital signature, or using biometric information, for example. Biometric information may include data obtained by an iris scan, fingerprint, voice pattern, or any other information which uniquely identifies a particular user. Mobile computing devices 12, 14 may include means for obtaining biometric information, such as a fingerprint scanner, for example, to facilitate user identification and authentication.

Once the computing device and/or user has been identified, a corresponding set or sets of managed data or information is identified on the computing device for synchronization. Corresponding synchronization information is then automatically exchanged between the collaboration cell client application and corresponding collaboration cell server application. The collaboration cell server application, or other application running on the collaboration cell server, reconciles differences in the managed data stored on the mobile computing device and the collaboration server based on the exchanged synchronization information. The reconciliation information is then transferred to the mobile computing device to provide a consistent image of the latest version of the managed data.

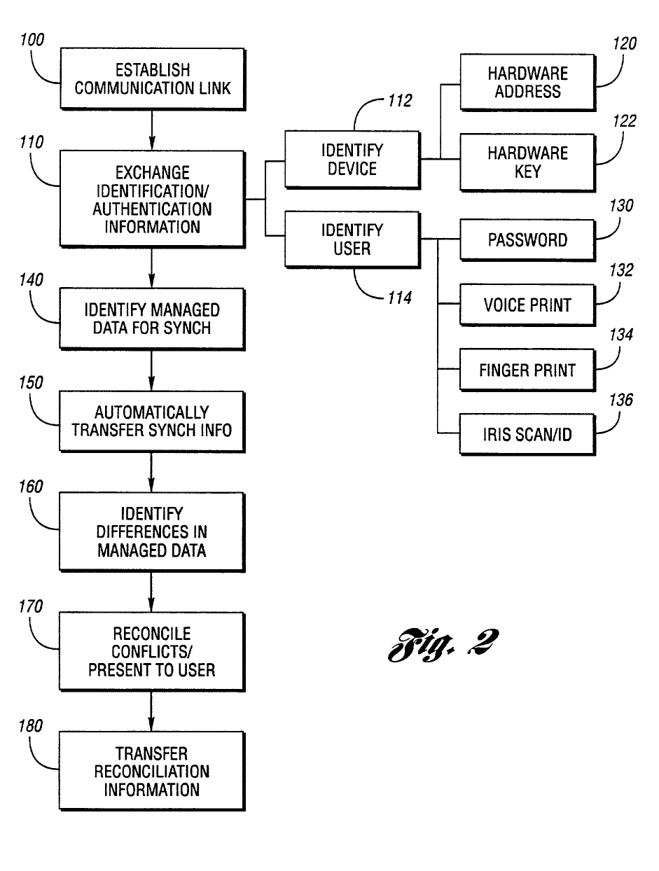

The diagram of FIG. 2 generally represents control logic for one embodiment of a system or method for synchronizing managed data according to the present invention. As will be appreciated by one of ordinary skill in the art, the diagram may represent any one or more of a number of known processing strategies such as event-driven, interrupt-driven, multi-tasking, multi-threading, parallel processing and the like. As such, various steps or functions illustrated may be performed in the sequence illustrated, in parallel, or in some cases omitted. Likewise, the order of processing is not necessarily required to achieve the objects, features, and advantages of the invention, but is provided for ease of illustration and description. Although not explicitly illustrated, one of ordinary skill in the art will recognize that one or more of the illustrated steps or functions may be repeatedly performed depending upon the particular step or function and processing strategy being used.

Preferably, the control logic is implemented primarily in software executed by a microprocessor-based computing device. Of course, the control logic may be implemented in software, hardware, or a combination of software and hardware depending upon the particular application. When implemented in software, the control logic is preferably provided in a computer-readable storage medium having stored data representing instructions executed by a computer. The computer-readable storage medium or media may be any of a number of known physical devices which utilize electric, magnetic, and/or optical devices to temporarily or persistently store executable instructions and associated information, operating variables, and the like. For example, the computer readable storage media may include random access memory (RAM), flash memory, floppy disk, hard disk, CD-ROM, DVD, or any of a number of solid state, magnetic, optical, and/or combination devices.

Block 100 of FIG. 2 represents establishing a communication link between two computing devices. As described above, a wireless communication link is preferably automatically established between a mobile computing device and a collaboration cell server to form an ad-hoc network or pico-network when the mobile computing device is within a predetermined proximity of the collaboration cell server or wireless access point. While any type of networking or communication link could be used for a collaboration cell implementation according to the present invention, wireless connections are most advantageous because they provide the most mobility. In addition, wireless networking could enable the collaboration cell capabilities only in specific locales.

After establishing a communication link, the computing device exchanges identification/authentication information with the collaboration cell server as represented by block 110. The identification/authentication information may be used to uniquely identify the user 112 and/or the mobile computing device 114. The identification/authentication information for the computing device may include a hardware address 120, hardware key 122, or the like. Identification/authentication information for the user may include a password 130 or biometric information such as a fingerprint 132, voice print 134, or iris identification 136. Once authenticated, the associated managed data stored on the mobile computing device is identified for synchronization as represented by block 140. Synchronization information corresponding to modifications of the managed data is then automatically transferred to the collaboration cell server as indicated by block 150. This step may include transferring the entirety of the managed data for comparison to the corresponding managed data on the collaboration server. However, to conserve system resources including power of the mobile computing device, and network bandwidth, for example, the synchronization information preferably includes only information necessary to convey the nature and source of modifications to the managed data.

As also illustrated in FIG. 2, differences in the managed data stored on the mobile computing device and the collaboration cell server are identified based on the synchronization information to generate reconciliation information as represented by block 160. Conflicting modifications may require manual intervention to determine which modifications to incorporate into the latest version of the managed data. If conflicting modifications are detected, corresponding information may be presented to a user as represented by block 170. However, depending upon the particular application, many modifications may be automatically reconciled. The reconciliation information is then transferred to the mobile computing device as represented by block 180. Similar to block 150, reconciliation information may include the reconciled managed data in its entirety, although it is often desirable to minimize the amount of information exchanged to conserve system resources.

As such, the present invention provides a system and method for synchronizing managed data to allow multiple portable computing devices to collaborate on the managed data. The present invention provides for automatic networking, synchronization, and revision control to leverage existing networking technologies.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for synchronizing managed data stored by at least first and second computing devices, the method comprising:
establishing a communication link between the first and second computing devices;
automatically identifying the managed data stored on the first computing device for synchronization;
automatically transferring synchronization information associated with the managed data stored on the first computing device to the second computing device over the communication link;
reconciling differences in the managed data stored on the first and second computing devices based on the synchronization information to generate reconciliation information; and
transferring the reconciliation information from the second computing device to the first computing device to synchronize the managed data.

2. The method of claim 1 wherein the step of establishing a communication link comprises establishing a wireless communication link.

3. The method of claim 2 wherein the step of establishing a wireless communication link comprises automatically establishing a wireless communication link based on proximity of the first and second computing devices.

4. The method of claim 2 wherein the wireless communication link is a radio frequency communication link.

5. The method of claim 1 wherein the step of establishing a communication link comprises exchanging authentication information.

6. The method of claim 5 wherein the authentication information includes information that uniquely identifies the first computing device.

7. The method of claim 6 wherein the authentication information includes a MAC address associated with a network interface card of the first computing device.

8. The method of claim 5 wherein the authentication information includes information that uniquely identifies a user of the first computing device.

9. The method of claim 8 wherein the authentication information includes biometric information associated with the user.

10. A method for synchronizing managed data stored on a mobile computing device and a stationary computing device, the method comprising:
automatically establishing a wireless communication link between the computing devices when the mobile computing device is within a predetermined proximity of the stationary computing device;
automatically identifying the managed data for synchronization based on authentication of at least one of the mobile computing device and an associated user; and
automatically exchanging synchronization information between the mobile and stationary computing devices such that the managed data stored on the mobile computing device matches the managed data stored on the stationary computing device.

11. The method of claim 10 wherein the step of automatically identifying the managed data comprises authenticating the associated user based on biometric information.

12. The method of claim 10 wherein the step of automatically identifying the managed data comprises authenticating the mobile computing device based on a hardware address.

13. The method of claim 10 further comprising presenting conflicting data based on the synchronization data to a user for reconciliation.

14. A system for synchronizing managed data, the system comprising:
a mobile computing device having a wireless communication interface and a first storage medium for storing managed data, the mobile computing device including a processor for running a synchronization client application; and
a synchronization server having a wireless communication interface and a second storage medium for storing managed data, the synchronization server including a processor for running a synchronization server application, wherein the synchronization server automatically establishes communication with the mobile computing device when the mobile computing device is within a predetermined area, automatically identifies the managed data on the mobile computing device, and automatically transfers synchronization information via the synchronization server and client applications and the wireless communication interfaces to the synchronization server, the synchronization server application reconciling differences between the managed data on the mobile computing device and the synchronization server to synchronize the managed data and transferring synchronized managed data to the mobile computing device.

15. The system of claim 14 further comprising:
means for uniquely identifying the mobile computing device;
wherein the synchronization server automatically transfers the synchronization information based on identity of the mobile computing device.

16. The system of claim 14 further comprising:
means for collecting biometric information associated with a user of the mobile computing device;
wherein the synchronization server authenticates the biometric information before automatically transferring the synchronization information.

17. A computer readable storage medium having stored data representing instructions executable by a computer for synchronizing managed data stored on a mobile computing device and a stationary computing device, the computer readable storage medium comprising:
instructions for automatically establishing a wireless communication link between the computing devices when the mobile computing device is within a predetermined proximity of the stationary computing device;
instructions for automatically identifying the managed data for synchronization based on authentication of at least one of the mobile computing device and an associated user; and
instructions for automatically exchanging synchronization information between the mobile and stationary computing devices such that the managed data stored on the mobile computing device matches the managed data stored on the stationary computing device.

18. The computer readable storage medium of claim 17 wherein the instructions for automatically identifying the managed data comprise instructions for authenticating the associated user based on biometric information.

19. The computer readable storage medium of claim 17 wherein the instructions for automatically identifying the managed data comprise instructions for authenticating the mobile computing device based on a hardware address.

20. The computer readable storage medium of claim 17 further comprising instructions for presenting conflicting data based on the synchronization data to a user for reconciliation.
